(19) United States
(12) Patent Application Publication
(10) Pub. No.: US 2005/0002498 A1
(43) Pub. Date: Jan. 6, 2005

(54) Method of notifying a caller of a telephone profile status

(76) Inventor: Yi-Ming Kao, Chia-I City (TW)

Correspondence Address: NAIPO (NORTH AMERICA INTERNATIONAL PATENT OFFICE), P.O. BOX 506, MERRIFIELD, VA, 22116, US

(21) Appl. No.: 10/609,531

(22) Filed: Jul. 1, 2003

(51) Int. Cl. H04M 1/64; H04M 11/10

(52) U.S. Cl. 379/88.12; 455/413

(57) ABSTRACT

A method for notifying a caller to a telephone of a profile status of the telephone. The telephone is connected to a telephone network. The method includes selecting a profile status of the telephone, transmitting the selected profile status of the telephone to the telephone network in response to selection of the profile status, and the telephone network notifying a caller of the selected profile status of the telephone when the caller calls the telephone and the user does not answer.

### BACKGROUND OF INVENTION

1. Field of the Invention

The present invention relates to a profile status of a telephone, and more specifically, to a method for notifying a caller to a telephone of a selected profile status of the telephone.

2. Description of the Prior Art

With the improvements being made in the telecommunications industry, staying in touch with friends, family, and colleagues has never been easier. On the other hand, there are times when a telephone user does not wish to be disturbed or is not able to answer an incoming call.

For example, suppose that the telephone is a mobile phone and the mobile phone user is driving home from work. If the user receives a call on the mobile phone while driving, the user will likely not be able to answer the phone for legal or safety reasons. Unfortunately, the caller has no way of knowing where the mobile phone user is or what the user is doing at the time of the call. The lack of information about the status of the mobile phone user may cause the caller to needlessly worry about the user, and to wonder why the user does not answer the phone.

### SUMMARY OF INVENTION

It is therefore a primary objective of the claimed invention to provide a method for notifying a caller to a telephone about a profile status of the telephone in order to solve the above-mentioned problems.

According to the claimed invention, a method for notifying a caller to a telephone of a profile status of the telephone is disclosed. The telephone is connected to a telephone network. The method includes selecting a profile status of the telephone, transmitting the selected profile status of the telephone to the telephone network in response to selection of the profile status, and the telephone network notifying a caller of the selected profile status of the telephone when the caller calls the telephone and the callee (telephone user) is not answering.

It is an advantage of the claimed invention that the telephone network notifies the caller of the profile status of the telephone so the caller can know what the telephone user is doing if the caller can not speak to the user directly.

These and other objectives of the claimed invention will no doubt become obvious to those of ordinary skill in the art after reading the following detailed description of the preferred embodiment, which is illustrated in the various figures and drawings.

### BRIEF DESCRIPTION OF DRAWINGS

FIG. 1 is a diagram of a first telephone communicating with a second telephone through a telephone network.

FIG. 2 is a flowchart illustrating the method of notifying a person calling with the second telephone of a profile status of the first telephone according to the present invention.

FIG. 3 is a chart showing status identification codes corresponding to various profile statuses.

FIG. 4 is a message sequence diagram illustrating the flowchart of FIG. 2 with an example.

### DETAILED DESCRIPTION

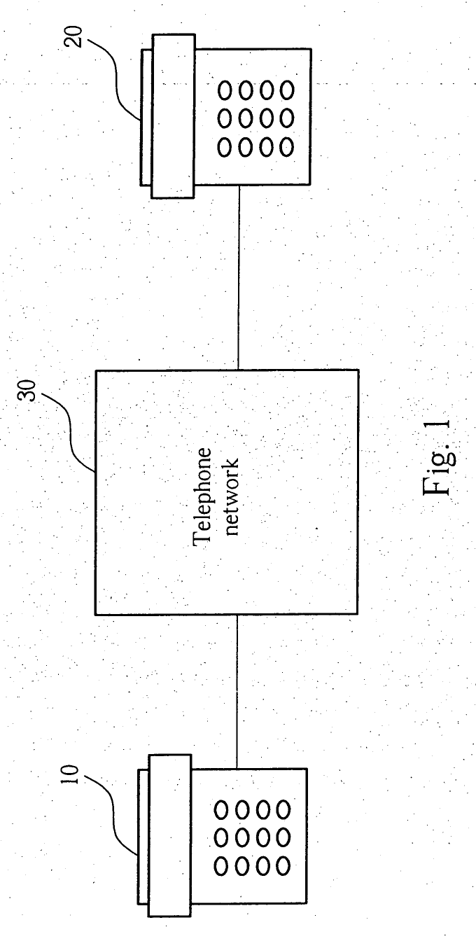

Please refer to FIG. 1. FIG. 1 is a diagram of a first telephone 10 communicating with a second telephone 20 through a telephone network 30. The first telephone 10 is preferably a mobile phone, but other telephones also fall within the scope of the present invention, as will be explained below.

A user of the first telephone 10 selects a profile status for the first telephone 10 when the user does not want to be disturbed or when the user will not be able to answer any incoming telephone calls. Example profile statuses include “in a meeting”, “driving car”, or “sleeping”. After the user of the first telephone 10 has selected the profile status, the first telephone 10 transmits the selected profile status to the telephone network 30. The primary purpose of the user of the first telephone 10 selecting the profile status is to inform callers of the status of the first telephone 10.

Suppose that a person using the second telephone 20 calls the user of the first telephone 10, and the user of the first telephone 10 does not answer. If the user of the first telephone 10 has already selected a profile status, the first telephone 10 will transmit the profile status to the telephone network 30 and the telephone network 30 will notify the person calling with the second telephone 20 of the selected profile status of the first telephone 10. In this way, the person calling with the second telephone 20 can immediately know what the status of the user of the first telephone 10 is, and will not needlessly wonder why the user of the first telephone 10 did not answer the call.

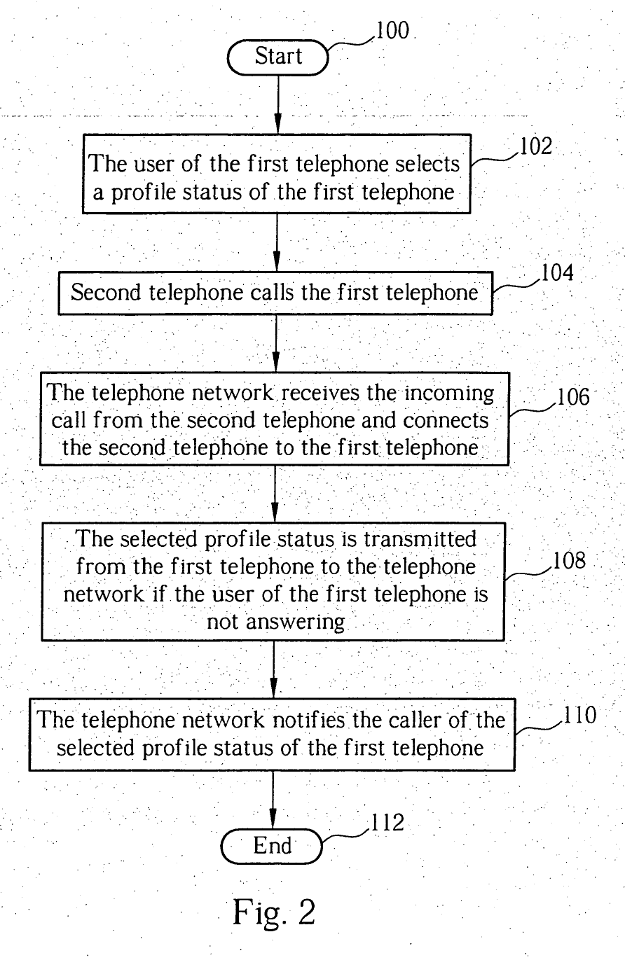

Please refer to FIG. 2. FIG. 2 is a flowchart illustrating the method of notifying the person calling with the second telephone 20 of the profile status of the first telephone 10 according to the present invention.

Step 100: Start;

Step 102: The user of the first telephone 10 selects a profile status of the first telephone 10;

Step 104: The person using the second telephone 20 calls the first telephone 10;

Step 106: The telephone network 30 receives the incoming call from the second telephone 20 and connects the second telephone 20 to the first telephone 10;

Step 108: The selected profile status “010” is transmitted from the first telephone 10 to the telephone network 30 if the user of the first telephone 10 is not answering;

Step 110: The telephone network 30 notifies the person calling with the second telephone 20 of the selected profile status of the first telephone 10; and

Step 112: End.

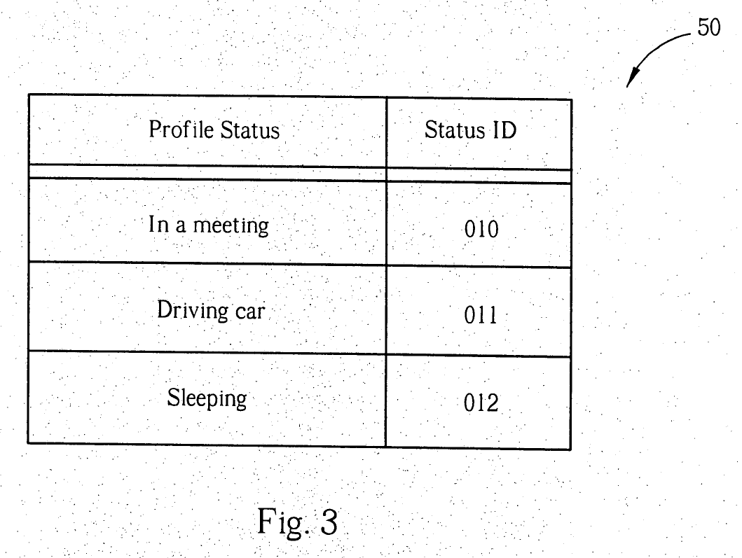

Please refer to FIG. 3. FIG. 3 is a chart 50 showing status identification codes corresponding to various profile statuses. The chart 50 shows three example profile statuses and their corresponding status ID codes. A profile status of “In a meeting” has a status ID code of “010”, a profile status of “Driving car” has a status ID code of “011”, and a profile status of “sleeping” has a status ID code of “012”.

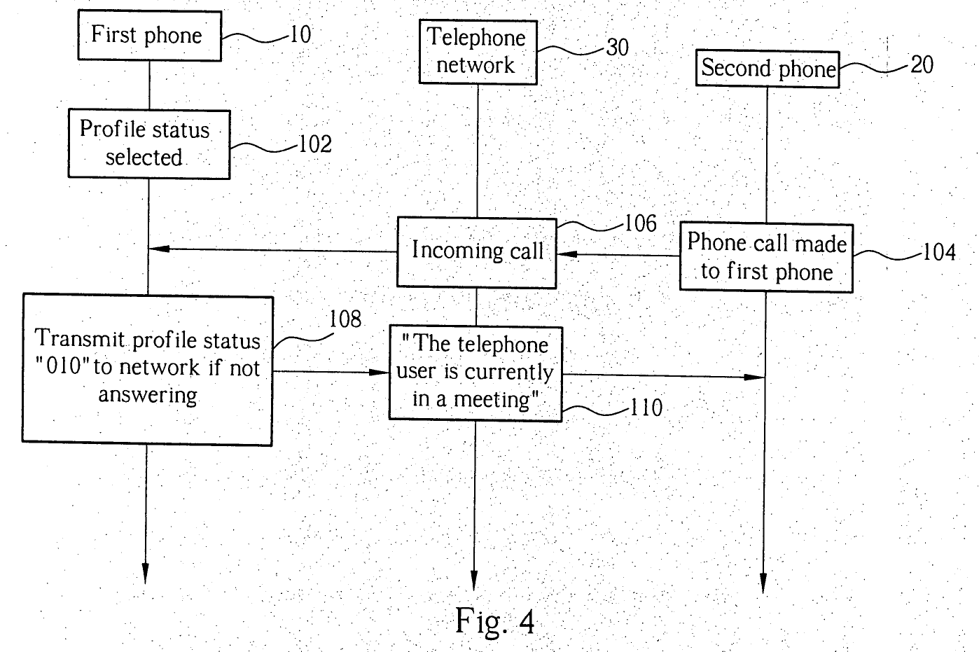

Please refer to FIG. 4. FIG. 4 is a message sequence diagram illustrating the flowchart of FIG. 2 with an example. In step 102, the user selects the profile status “In a meeting” for the first telephone 10. Instep 104, the person using the second telephone 20 calls the first telephone 10 through the phone network. In step 106, the network receives the incoming call from the second telephone 20 and connects the second telephone 20 to the first telephone 10. In step 108, the first telephone transmits the selected profile status “010” to the telephone network 30 if the user of the first telephone 10 is not answering. In step 110, the telephone network 30 translates the status ID code “010” into a voice message “The telephone user is currently in a meeting” and transmits this voice message to the second telephone 20.

The present invention preferably uses a mobile phone for the first telephone 10 and a mobile phone network for the telephone network 30. Since all calls to a mobile phone must go through the mobile phone network, the present invention method can easily be implemented with the existing mobile phone network infrastructure. The firmware of mobile phones should be upgraded to transmit the profile status to the mobile phone network. Additionally, the mobile phone network should be capable of translating the profile status to a corresponding voice message, (ex: “The telephone user is currently in a meeting”), to inform callers of the profile status. However, the present invention is not limited to using mobile phones as the first telephone 10. The present invention method can use any telephone as the first telephone 10 for selecting a profile status, so long as the telephone network 30 is able to receive the selected profile status from the first telephone 10 and inform callers of the selected profile status.

Compared to the prior art, the present invention method uses the telephone network to automatically notify callers to a telephone of the profile status of the telephone. Therefore, the caller can directly learn the status of the telephone user quickly and easily.

Those skilled in the art will readily observe that numerous modifications and alterations of the device may be made while retaining the teachings of the invention. Accordingly, the above disclosure should be construed as limited only by the metes and bounds of the appended claims.

1. A method of notifying a caller to a telephone of a profile status of the telephone, the telephone being connected to a telephone network, the method comprising:
selecting a profile status of the telephone;
transmitting the selected profile status of the telephone to the telephone network in response to selection of the profile status; and
the telephone network notifying a caller of the selected profile status of the telephone when the caller calls the telephone and the user does not answer.

2. The method of claim 1 wherein the telephone is a mobile phone.

3. The method of claim 2 wherein the telephone network is a mobile phone network.

4. The method of claim 1 wherein the telephone transmits the selected profile status to the telephone network as an identification code.

5. The method of claim 4 wherein the telephone network translates the identification code into a corresponding voice message for notifying the caller of the selected profile status of the telephone.
